(19) United States
(12) Patent Application Publication
(10) Pub. No.: US 2012/0119092 A1
(43) Pub. Date: May 17, 2012

(54) SCINTILLATING MATERIAL HAVING LOW AFTERGLOW

(75) Inventors: Samuel Blahuta, Paris (FR); Eric Mattmann, Paris (FR); Damien Pauwels, Mandelieu (FR); Bruno Viana, Montgeron (FR)

(73) Assignee: SAINT-GOBAIN CRISTAUX ET DETECTEURS, Courbevoie (FR)

(21) Appl. No.: 12/977,947

(22) Filed: Dec. 23, 2010

(30) Foreign Application Priority Data
Nov. 16, 2010 (FR) 1059394

(51) Int. Cl. G01T 1/20; C09K 11/79

(52) U.S. Cl. 250/361 R; 252/301.4 F

(57) ABSTRACT

The invention relates to a scintillator material comprising a cerium-doped rare-earth silicate, characterized in that its absorbance at a wavelength of 357 nm is less than its absorbance at 280 nm. This material has an afterglow of generally less than 200 ppm after 100 ms relative to the intensity measured during an X-ray irradiation. It is preferably codoped. It may be obtained using an oxidizing anneal. It is particularly suited to integration in an ionizing particle detector that may be used in a medical imaging apparatus.

The invention relates to scintillating materials, to a manufacturing method allowing them to be obtained and to the use of said materials, especially in gamma-ray and/or X-ray detectors.

Scintillating materials are widely used in detectors for detecting gamma rays, X-rays, cosmic rays and particles having an energy of the order of 1 keV or more.

A scintillating material is a material that is transparent in the scintillation wavelength range and that responds to an incident ray by emitting a light pulse.

Such materials, which may be ceramics or polycrystalline powders, thin films or single-crystal fibers, but which are most often single crystals, may be used to manufacture detectors in which the light emitted by the crystal used in the detector is collected by a light detection means that produces an electrical signal proportional to the number of photons received. Such detectors are used, especially in industry, for coating weight or thickness measurements, and in the fields of nuclear medicine, physics, chemistry and oil exploration.

One family of known and used scintillating crystals is that of the rare-earth silicates, especially cerium-doped lutetium silicate. Cerium-doped Lu₂SiO₅ is described in U.S. Pat. No. 4,958,080. The patent U.S. Pat. No. 6,624,420 describes Ce₂ₓ(Lu_{1-y}Y_{y})₂₍₁₋ₓ₎SiO₅. Finally, U.S. Pat. No. 6,437,336 relates to Lu₂₍₁₋ₓ₎M₂ₓSi₂O₇ compositions, where M is at least partially cerium. These various scintillating compositions all have in common a high-stopping power for high-energy rays and intense light output with very fast light pulses.

It is also desirable to reduce the amount of light emitted after the incident radiation stops—called the afterglow. Physically, this afterglow, well known to those skilled in the art, is explained by the presence of electron traps in the crystallographic structure of the material. Scintillation is based on the photoelectric effect, which creates electron-hole pairs in the scintillating material. Upon recombining, on an active site, each electron emits photons. The aforementioned scintillators, which are particularly fast, result in a pulse duration that decreases with a first-order exponential constant of about 40 ns. In contrast, the trapped electrons do not immediately generate light, but their detrapping by thermal excitation (including at room temperature) gives rise to photon emission (the afterglow), which still remains measurable after times of greater than one second.

This effect may be unacceptable in applications in which it is desired to isolate each pulse, using very short windowing. This is particularly the case with CT (computed tomography) applications (scanners) that are well known in the medical or industrial sectors. When the CT system is coupled to a PET (Positron Emission Tomography) scanner, which is becoming standard practice in industry, the poorer resolution of the CT affects the performance of the entire system and therefore the capability of the clinician to interpret the result of the combined PET/CT system. Afterglow is known to be completely unacceptable for these applications.

The lutetium silicate compositions disclosed in US 4 958 080 (denoted LSO:Ce by those skilled in the art) and U.S. Pat. No. 6,624,420 (denoted LYSO:Ce by those skilled in the art) are known to generate a significant afterglow. One way of reducing this effect is proposed in WO 2006/018586 and consists in introducing into the material a divalent alkaline-earth ion or a trivalent metal. Introducing these codopants improves the afterglow.

The afterglow property may be demonstrated more fundamentally by thermoluminescence (see S. W. S. McKeever, “Thermoluminescence of Solids”, Cambridge University Press (1985)). This characterization consists in thermally exciting a specimen after irradiation and measuring the light emission. A light peak close to room temperature at 300 K corresponds to an afterglow of greater or lesser magnitude depending on its intensity (detrapping). A peak at a higher temperature corresponds to the existence of traps that are deeper and therefore less susceptible to thermal excitation at room temperature.

Thermoluminesence measurements may be carried out using apparatus such as that described below. A sample having a thickness of about 1 mm and an area of 10 mm×10 mm is bonded, using a silver paint, to a copper sample-carrier that is attached to the end of the cooling head of a cryostat, such as that marketed by Janis Research Company. The cryostat itself is cooled using a helium compressor. Before each measurement the crystals are heated for a few minutes at 650 K. The sample is excited in situ, at low temperature (10 K in general), for a certain time by an X-ray source (for example a PhilipsTM molybdenum X-ray tube operating at 50 kV and 20 mA) or by a UV lamp. The excitation beam passes through a beryllium window in the cryostat, the cryostat having previously been pumped down to about 10⁻⁵ mbar using an Adixen Drytel pumping group, and arrives at the sample at an angle of 45° . A LakeShore 340 temperature controller allows the sample to be heated at a constant rate. Luminescence from the samples is collected via an optical fiber by a CCD (charge coupled device) camera, cooled to −65° C. and equipped with an Acton SpectraPro 1250i monochromator and a diffraction grating, for spectral resolution of the signal. The emitted light is collected on the same side of the sample as that on which it is excited and at an angle of 45° relative to its surface. The thermoluminescence curves are recorded for a constant sample heating rate between 10 K and 650 K.

Measurements at higher temperatures are not possible because of black body radiation (“black body radiation” is the light spontaneously emitted by a substance when it is heated to incandescence). Each curve is normalized with respect to the mass of product.

Patents U.S. Pat. No. 7,151,261 and U.S. Pat. No. 7,166,845 teach heat treatment of LSO, YSO or LYSO silicates:
a) the crystal was grown using the Czochralski method in an argon or nitrogen atmosphere, or under vacuum, with less than 1% oxygen present, so as to form a transparent, colorless crystal (in certain cases the oxygen content was greater because of leaks, leading instead to a yellow crystal that the Applicant attributed to the presence of Ce⁴⁺); then
b) the crystal was annealed in an oxidizing atmosphere at a temperature low enough that Ce⁴⁺ was not formed because this ion was thought to be a nonemitter (i.e. nonscintillating) and in addition, it colored the material yellow.

Afterglow is linked to electronic defects. It has now been discovered that these defects are linked entirely to the presence of oxygen vacancies in the material. It was noticed that samples codoped with calcium, magnesium or aluminum contained fewer oxygen vacancies and that they absorbed strongly between 150 nm and 350 nm. An effort was made to find out the cause of this absorption band, and its origin was found to be the Ce⁴⁺ ion. It was unexpected to find so much Ce⁴⁺, especially in compositions having an improved afterglow, since those skilled in the art generally consider the presence of this ion to be disadvantageous—because it does not scintillate, and because it colors the material. This preconception is especially found in the following documents:
Z. Assefa, R. G. Haire, D. L. Caulder and D. K. Shuh, Spectrochimica Acta. Part A 60 (2004) 1873-1881;
U.S. Pat. NO. 7,166,845;
U.S. Pat. No. 7,151,261;
U.S. Pat. No. 7,397,034;
U.S. Pat. No. 6,278,832;
D. Ding, H. Feng, G. Ren, M. Nikl, L. Qin, S. Pan and F. Yang, IEEE Transactions On Nuclear Science 57 (2010) 1272-1277;
Y. Kuruta, K. Kurashige and H. Ishibashi, IEEE Transactions On Nuclear Science 42 (1995) 1038;
C. Melcher, S. Friedrich, S. Cramer, M. Spurrier, P. Szupryczynski and R. Nutt, IEEE Transactions On Nuclear Science 52 (2005) 1809-1812; and
N. Shimura, M. Kamada, A. Gunji, S. Yamana, T. Usui, K. Kurashige, H. Ishibashi, N. Senguttuvan, S. Shimizu, K. Sumiya and H. Murayama, IEEE Symposium Conference Record Nuclear Science (2004).

In particular, in the document by D. Ding, H. Feng, G. Ren, M. Nikl, L. Qin, S. Pan and F. Yang (IEEE Transactions On Nuclear Science 57 (2010) 1272-1277) it is taught that Ce⁴⁺ is a nonradiative center and that it is linked to a low light yield. Analysis of FIG. 7 in that document showed an A₃₅₇/A₂₈₀ ratio of 1.36. In light of the present invention it is now understood that this ratio is characteristic of the presence of Ce⁴⁺ in a certain amount.

Likewise, in the document by B. Hautefeuille, K. Lebbou, C. Dujardin, J. Fourmigue, L. Grosvalet, 0. Tillement and C. Pedrini (Journal Of Crystal Growth 289 (2006) 172-177), it is asserted that Ce⁴⁺ is absent in compounds obtained using the pulling-down method. The spectrum in FIG. 7 of that document shows an A₃₅₇/A₂₈₀ ratio of about 1.1. In light of the present invention, it is now understood that this ratio is characteristic of the presence of Ce⁴⁺ in a certain amount.

It has now been realized that these preconceptions concerning Ce⁴⁺ were groundless. In the context of the present application, cerium (in the Ce³⁺ and Ce⁴⁺ states) is called the dopant and other optional metal (e.g. Al) or alkaline-earth elements other than cerium are called codopants.

The object of the present invention is to limit the afterglow in a cerium-doped rare-earth silicate scintillator. The expression “a rare-earth silicate” of course covers the eventuality of a silicate of more than one rare earth. The expression “cerium-doped rare-earth silicate” implies that the principal rare earth in the silicate is not cerium. The silicate according to the invention contains cerium in an amount that generally represents from 0.005 mol % to 20 mol % of all the rare earths in the material (including the cerium itself and any yttrium that might be present). It is recalled that Y is likened to a rare earth by those skilled in the art.

The scintillating material according to the invention may also have an afterglow of less than 200 ppm after 100 ms relative to the intensity measured during an X-ray irradiation. It has also been noted that the improvement in the afterglow is generally accompanied by a reduction in the decay time and an increase in the light yield. The scintillating material according to the invention is particularly suited to integration into an ionizing particle detector, such as those found in medical imaging apparatus, e.g. PETs and CT (computed tomography) scanners, or in high-energy nuclear physics experiments or finally in tomographs used in the nondestructive inspection of objects such as luggage.

The material according to the invention is generally transparent and colorless to the naked eye, despite the presence of Ce⁴⁺. It is possible to define its yellowing index using the L*, a*, b* color coordinates, in the CIELAB space, obtained during a transmission measurement. These coordinates are commonly used in the glass industry. It is especially possible to use a spectrophotometer marketed by Varian under the trade name Cary 6000i. By way of example, a 1 mm thick yellow-colored sample of a Ce-doped LYSO crystal having both sides polished and parallel may have the following color coordinates:

| L* | a* | b* |
|---|---|---|
| 93.79 | 0.01 | 0.77 |

By way of example, a 1 mm thick non-yellow-colored Ce-doped LYSO crystal considered to be colorless and having both sides polished and parallel may have the following color coordinates:

| L* | a* | b* |
|---|---|---|
| 93.74 | 0.12 | 0.29 |

The higher L*, the greater the transparency of the material. The crystals according to the invention have an L* coordinate higher than 93 for a 1 mm thick sample having both sides polished and parallel. It is recalled that L* is at most 100.

The higher b*, the yellower the crystal. The crystals according to the invention have a b* coordinate in the range running from 0 to 0.4 for a 1 mm thick sample having both sides polished and parallel.

The higher a*, the redder the crystal. The more negative a*, is the greener the crystal. The crystals according to the invention have an a* coordinate in the range running from −0.1 to +0.1 for a 1 mm thick sample having both sides polished and parallel.

The invention firstly relates to a scintillating material comprising a cerium-doped rare-earth silicate having an absorbance at the wavelength of 357 nm that is less than its absorbance at 280 nm. This absorbance characteristic implies that Ce⁴⁺ is present in a quantity great enough to improve the afterglow. The absorbances at the wavelengths of 357 nm and 280 nm are compared after subtracting the background noise, subtracting the background noise being a logical step for those skilled in the art.

The presence of Ce⁴⁺ in the cerium-doped rare-earth silicates may be achieved in various ways:
1) it is possible to add a codopant that has a lower valence than the element it substitutes in the crystal matrix, for example an element having a valence of 1 or 2 may be used to substitute a rare earth (Y, La, Ce, Pr, Nd, Pm, Sm, Eu, Gd, Tb, Dy, Ho, Er, Tm, Yb, Lu), or an element having a valence of 1, 2 or 3 may be used to substitute silicon;
2) it is possible to anneal (between 1100° C. and 1600° C.), under oxidizing conditions, a material containing oxygen vacancies. A material containing oxygen vacancies is obtained by synthesizing it in a sufficiently reducing atmosphere, i.e. containing less than 5 vol % and preferably less than 1 vol % of oxygen. For this synthesis, the raw materials are first melted (generally a temperature below 2200° C. is enough to melt them) then cooled and crystallized. For the anneal under oxidizing conditions, it is possible, for example, to use an atmosphere containing at least 10 vol % of oxygen, preferably at least 20 vol % of oxygen—for example, air may be used. Oxidizing conditions may be achieved by electrical discharge in the material. The amount of oxygen in the oxidizing atmosphere used for this annealing treatment may be very high, the use of pure oxygen not being ruled out; however, an oxygen content of less than 30 vol % is generally enough; and
3) it is also possible to grow the material under oxidizing conditions, for example in an atmosphere containing at least 10 vol % and preferably at least 20 vol % of oxygen, or in the presence of an oxidizing chemical species (chromium, silica, etc.). However, the presence of such an amount of oxygen at high temperature means that a crucible made of iridium, which oxidizes easily, cannot be used. It is however possible, for example, to implement this variant using the following techniques: mirror furnace and cold crucible. In this variant, the mixture of raw materials is melted. Generally a temperature below 2200° C. is enough to cause the raw materials to melt. As required, after crystal synthesis, an anneal under oxidizing conditions (at least 10 vol % and preferably at least 20 vol % of oxygen—for example in air) may optionally be carried out so as to cause the formation of even more Ce⁴⁺. The amount of oxygen in the oxidizing atmosphere used for this material growth or the annealing treatment may be very high, the use of pure oxygen not being ruled out; however, an oxygen content of less than 30 vol % is generally enough.

The methods according to the invention are especially method 3), the combination of methods 1) and 2) or the combination of methods 1) and 3).

Thus the invention also relates to a method for preparing a scintillating material comprising an oxidizing heat treatment at a temperature of between 1100 and 2200° C. in an atmosphere containing at least 10 vol % of oxygen, followed by cooling that results in said material, said heat treatment and said cooling both being carried out in an atmosphere containing at least 10 vol % or even 20 vol % of oxygen when the temperature is greater than 1200° C. and preferably when the temperature is greater than 1100° C. Between the oxidizing heat treatment and the cooling there is no treatment that is so reducing that the absorbance at the wavelength of 357 nm is no longer less than its absorbance at 280 nm after subtracting the background noise. This is what is meant when it is said that the oxidizing heat treatment is followed by cooling that results in the final, solid material. The latter may especially be a single crystal.

Especially in the case of variant 2) above, the method according to the invention comprises melting raw materials (in the form of oxides or carbonates, etc.) in an atmosphere containing less than 5 vol % of oxygen and preferably less than 1 vol % of oxygen followed by cooling that results in solidification (generally crystallization, including single-crystal growth), followed by the oxidizing heat treatment, which is carried out up to a temperature of between 1100 and 1600° C.

The scintillator according to the invention comprises a cerium-doped, rare-earth silicate, said rare earth being generally chosen from among Y, La, Pr, Nd, Sm, Eu, Gd, Tb, Dy, Ho, Er, Tm, Yb and Lu. The rare earth in the silicate (other than Ce) may be a mixture of more than one rare earth chosen from among Y, La, Pr, Nd, Sm, Eu, Gd, Tb, Dy, Ho, Er, Tm, Yb and Lu.

The scintillating material according to the invention is preferably codoped with a divalent alkaline-earth element such as Ca, Mg or Sr and/or a trivalent metal such as Al, Ga or In. The trivalent metal is neither a rare earth nor an element likened to a rare earth. The trivalent metal is therefore not chosen from among Y, La, Ce, Pr, Nd, Sm, Eu, Gd, Tb, Dy, Ho, Er, Tm, Yb and Lu. A divalent alkaline-earth codopant may be present in a proportion from 0.0025 mol % to 15 mol % of all the rare earths in the material (including cerium, and the optional Y likened to a rare earth). A trivalent metal codopant may be present in a proportion from 0.005 mol % to 25 mol % of the sum of the moles of silicon and trivalent metal codopant included in the material. Generally, the sum of the masses of the codopants in the material is less than the mass of the cerium, and even less than 0.1 times the mass of cerium, in the material.

The scintillating material according to the invention may especially have the general formula:

Ln_{(2-z-x)}CeₓM_{z}Si₍ₚ₋ᵥ₎M′ᵥO₍₃₊₂ₚ) (formula I)

in which:

Ln represents a rare earth;

M represents a divalent alkaline earth element such as Ca, Mg or Sr; and

M′ represents a trivalent metal such as Al, Ga or In;

(z+v) being greater than or equal to 0.0001 and less than or equal to 0.2;

z being greater than or equal to 0 and less than or equal to 0.2;

v being greater than or equal to 0 and less than or equal to 0.2;

x being greater than or equal to 0.0001 and less than 0.1; and

p being equal to 1 or 2.

The scintillating material according to the invention may especially have the formula:

Lu_{(2-y)}Y_{(y-z-x)}CeₓM_{z}Si₍₁₋ᵥ₎M′ᵥO₅ (formula II)

in which:

M represents a divalent alkaline-earth element such as Ca, Mg or Sr; and

M′ represents a trivalent metal such as Al, Ga or In;

(z+v) being greater than or equal to 0.0001 and less than or equal to 0.2;

z being greater than or equal to 0 and less than or equal to 0.2;

v being greater than or equal to 0 and less than or equal to 0.2;

x being greater than or equal to 0.0001 and less than 0.1; and

y being from (x+z) to 1.

Preferably, (z+v) is greater than or equal to 0.0002.

Preferably, (z+v) is less than or equal to 0.05 and even more preferably less than or equal to 0.01, and may even be less than 0.001.

Preferably, x is greater than 0.0001 and less than 0.001.

In particular, y may range from 0.08 to 0.3.

In particular, v may be zero (absence of M′), in which case z is at least 0.0001.

In particular, the scintillating material according to the invention may be such that v is zero. Again, the scintillating material according to the invention may be such that M is Ca, corresponding to a particularly suitable composition. The combination of v being zero and M being Ca is particularly suitable. The composition according to the invention then has the following formula:

Lu_{(2-Y)}Y_{(y-z-x)}CeₓCa_{z}SiO₅ (formula III)

Again, the scintillating material according to the invention may especially be such that z is zero. Again, the scintillating material according to the invention may especially be such that M′ is Al. The combination of z being zero and M′ being Al is particularly suitable. The composition according to the invention has then the following formula:

Lu_{(2-y)}Y_{(y-x)}CeₓAlᵥSi₍₁₋ᵥ₎O₅, (formula IV)

The molar content of the element 0 is substantially five times that of (Si+M′), it being understood that this value may vary by about ±2%.

The scintillating material according to the invention may also have a composition that does not correspond to that of formula IV above. The scintillating material according to the invention may also have a composition that does not correspond to that of formula III above. The scintillating material according to the invention may also have a composition that does not correspond to that of formula II above. The scintillating material according to the invention may also have a composition that does not correspond to that of formula I above.

In formulae I to IV above, the expression “Ln represents a rare earth” of course also covers the possibility of Ln representing one or more rare earths, the same also holding true for the expression “M represents a divalent alkaline-earth element”, “M′ represents a trivalent metal”, etc.

The scintillating material according to the invention may be obtained in single-crystal form by Czochralski growth. The raw materials may generally be introduced in the form of oxides or carbonates. These raw materials are melted in a controlled atmosphere in a crucible that may be made of iridium. Segregation effects, causing the final crystal to have in general a different composition to that corresponding exactly to the raw materials introduced, are taken into account. Those skilled in the art may easily determine the segregation factors using routine tests.

The invention also relates to an ionizing particle detector comprising a scintillating material according to the invention and a photoreceiver. The invention also relates to a medical imaging apparatus comprising the detector according to the invention.

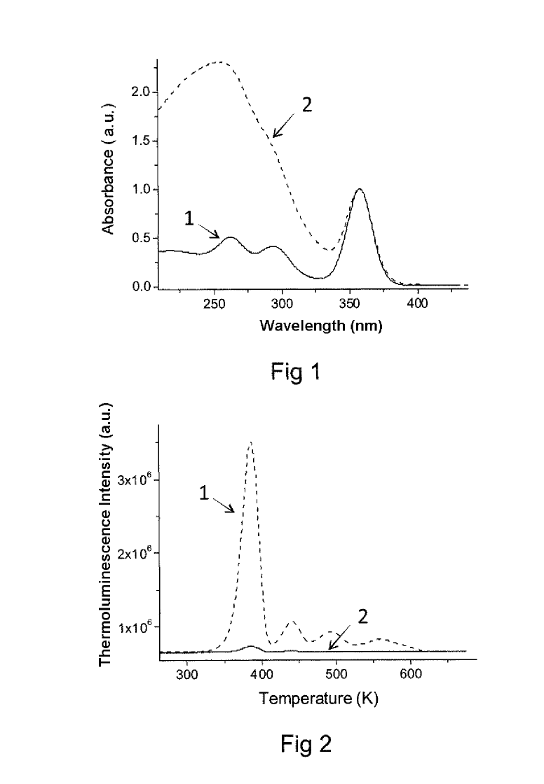

FIG. 1 shows the absorbance spectra in the case of example 2 (referenced “2” in the figure) after an air annealing (according to the invention) and in the case of example 1 (referenced “1” in the figure), a reference sample, representative of the prior art, that was not annealed. In the case of example 2, after an air annealing according to the invention, an absorbance maximum is observed at 250 nm, the origin of which is Ce⁴⁺.

FIG. 2 compares the thermoluminescence intensity of a compound in the case of example 2 (referenced “2”) after an air annealing according to the invention and in the case of example 1 (unannealed reference sample, referenced “1”) representative of the prior art. In the case of the example according to the invention, a very substantial drop in the thermoluminescence intensity, especially around 300 K, is noticed—characteristic of reduced afterglow.

### EXAMPLES 1 to 4

Lu, Y, Ce and Si oxides and optional codopants such as Mg or Al oxides or Ca carbonate were placed into an iridium crucible in the proportions shown in table 1. The values in table 1 are given in grams per kilogram of the total raw materials. All the compounds contain 10 at% of yttrium and 0.22 at% of cerium.

TABLE 1

| | Comparative | | | |
|---|---|---|---|---|
| | Example 1 | | | |
| | (reference) | Example 2 | Example 3 | Example 4 |
| Lu₂O₃ | 811.66 | 811.50 | 811.39 | 811.66 |
| Y₂O₃ | 51.16 | 51.16 | 51.16 | 51.17 |
| CeO₂ | 0.86 | 0.86 | 0.86 | 0.86 |
| SiO₂ | 136.32 | 136.25 | 136.41 | 136.19 |
| CaCO₃ | — | 0.23 | — | — |
| MgO | — | — | 0.18 | — |
| Al₂O₃ | — | — | — | 0.12 |

The charges were heated above their melting point (about 2050° C.) in a nitrogen atmosphere that was slightly oxidizing but that contained less than 1% oxygen. A single crystal measuring one inch in diameter was grown using the Czochralski method. To do this, a mixture of the raw materials corresponding to the following compounds was used:

### Comparative Example 1

### Reference without Codopant

Lu_{1.798}Y_{0.1976}Ce_{0.0044}SiO₅;

### Example 2

Lu_{1.798}Y_{0.1956}Ca_{0.002}Ce_{0.0044}SiO₅;

### Example 3

Lu_{1.798}Y_{0.1956}Mg_{0.001}Ce_{0.0044}SiO₅; and

### Example 4

Lu_{1.798}Y_{0.1966}Ca_{0.001}Ce_{0.0044}S_{0.999}Al_{0.001}O₅.

The formulae just given correspond therefore to the raw materials introduced. The actual concentrations of Ce, Ca, Mg and Al in the final crystal were lower than those introduced by the raw materials due to segregation during crystal formation. The samples of example 4 contained the elements Ca and Al, which may coexist according to the invention. The respective quantities of Ca and Mg are referenced z′ and z″, (with z=z′+z″).

The single crystals finally obtained, of formula:

Lu_{(2-y)}Y_{(y-′-z″-x)}CeₓCa_{z}′Mg_{z}″Si₍₁₋ᵥ₎AlᵥO₅

had the following compositions in the boule head:

TABLE 2

| | Comparative | | | |
|---|---|---|---|---|
| | Example 1 | | | |
| | (reference) | Example 2 | Example 3 | Example 4 |
| x | 0.00106 | 0.00054 | 0.00054 | 0.00070 |
| y | 0.2015 | 0.2016 | 0.2017 | 0.2016 |
| z′ | 0 | 0.00036 | 0 | 0.00010 |
| z″ | 0 | 0 | 0.00008 | 0 |
| v | 0 | 0 | 0 | 0.00003 |

and the following compositions in the boule heel:

TABLE 3

| | Comparative | | | |
|---|---|---|---|---|
| | Example 1 | | | |
| | (reference) | Example 2 | Example 3 | Example 4 |
| x | 0.00188 | 0.00186 | 0.000182 | 0.00148 |
| y | 0.2010 | 0.2008 | 0.2008 | 0.2011 |
| z′ | 0 | 0.00047 | 0 | 0.00028 |
| z″ | 0 | 0 | 0.00048 | 0 |
| v | 0 | 0 | 0 | 0.00012 |

The crystals obtained were all transparent and colorless and such that their L* coordinate was greater than 93, and at most equal to 100, for a 1 mm thick sample having both sides polished and parallel, their b* coordinate ranged from 0 to 0.4 for a 1 mm thick sample having both sides polished and parallel, and their a* coordinate ranged from −0.1 to +0.1 for a 1 mm thick sample having both sides polished and parallel.

At this stage, the crystal contained oxygen vacancies. After return to room temperature, the crystals were cut into 10×10×1 mm wafers. These crystals either underwent an anneal in air (oxidizing atmosphere) at 1500° C. for 48 hours, or a reducing anneal in argon containing 5% hydrogen at 1200° C. for 12 hours or no particular treatment was carried out. The large, parallel sides of the samples were then polished.

Next, the absorbance (also called the optical density) of each crystal was measured as a function of wavelength between 600 nm and 190 nm using a UV-visible spectrometer, and the corresponding curves were plotted. This allowed the ratio of the absorbance at 357 nm to the absorbance at 280 nm, referenced A₃₅₇/A₂₈₀, to be calculated after subtraction of the background noise, which corresponded to the absorbance at 600 nm for example. The background noise may especially be automatically subtracted by calibrating the measurement apparatus for 100% transmission and 0% transmission.

To measure the absorbance in the range allowing the Ce⁴⁺ to be characterized, it was possible to use a spectrophotometer measuring in the UV and in the visible, marketed by Varian under the trade name Cary 6000i, and having a resolution of less than or equal to 1 nm. The direct transmission mode was used on samples polished on their two parallel sides, through which sides the operation was carried out. The distance between these parallel sides (thickness of the sample) may be from 0.2 to 50 mm. A 1 mm thick sample gave excellent results. Measuring a sample using an interval of 0.5 nm, an acquisition time of 0.1 s per point and an SBW (spectral bandwidth) of 2 nm gave excellent results.

The results are collated in table 4. The afterglows are given in ppm relative to the intensity measured during the X-ray irradiation.

TABLE 4

| | Growth | Annealing | | Afterglow at |
|---|---|---|---|---|
| | atmosphere | atmosphere | A₃₅₇/A₂₈₀ | 100 ms (ppm) |
| Reference | N₂ < 1% O₂ | — | 2.7 | 270 |
| Example 1 | N₂ < 1% O₂ | Air | 2.5 | 237 |
| | N₂ < 1% O₂ | Ar + 5% H₂ | 4.5 | 646 |
| Example 2 | N₂ < 1% O₂ | — | 0.7 | 182 |
| Ca_{0.002} | N₂ < 1% O₂ | Air | 0.6 | 50 |
| | N₂ < 1% O₂ | Ar + 5% H₂ | 1.2 | 351 |
| Example 3 | N₂ < 1% O₂ | — | 1.2 | 436 |
| Mg_{0.002} | N₂ < 1% O₂ | Air | 0.9 | 84 |
| | N₂ < 1% O₂ | Ar + 5% H₂ | 1.9 | 889 |
| Example 4 | N₂ < 1% O₂ | — | 0.98 | Not measured |
| Al_{0.001} | N₂ < 1% O₂ | Air | 0.82 | 117 |
| | N₂ < 1% O₂ | Ar + 5% H₂ | 2.07 | Not measured |
| Examples | 100% O₂ | — | 0.5 | Not measured |
| 5 to 8 | Ar 21% O₂ | — | 0.8 | |
| | Ar 1.4% O₂ | — | 0.6 | |
| | Ar < 1% O₂ | — | 0.8 | |

### Examples 5 to 8

Lu, Y, Ce and Si oxides and Ca carbonate were mixed in the following proportions:

Lu₂O₃: 97.393 g

Y₂O₃: 6.1415 g

CeO₂: 0.1029 g

SiO₂: 16.3585 g

CaCO₃: 0.0062 g thereby resulting in a total mass of 120 g.

This mixture of raw materials corresponded to the following formula:

Lu_{1.798}Y_{0.1995}Ce_{0.0022}Ca_{0.0003}SiO₅.

This powder mixture was shaped into four, 3 mm diameter, 100 mm long cylindrical bars under an isostatic pressure of 700 kg/cm². These bars were then sintered in air at 1500° C. for 13 hours, ground once more into a powder and then reshaped into bars and sintered in air at 1500° C. for 20 hours. The succession of these two steps allowed the homogeneity of the bars prepared to be optimized. Polycrystalline LYSO bars were thus obtained. These bars were then placed in a mirror furnace in a controlled atmosphere so as to obtain single crystals using an LYSO single-crystal seed of the same composition but without codopant. The controlled atmosphere was, depending on the circumstances, 100% O₂ or 21% O₂ in argon or 1.4% O₂ in argon or 100% argon (the % values are by volume). On account of the technique used (mirror furnace), the composition of the crystals obtained was identical to that corresponding to the raw materials introduced. Thus, four transparent colorless single crystals were obtained. They were cut and polished. The crystals obtained were such that their L* coordinate was greater than 93 for a 1 mm thick sample having both sides polished and parallel, their b* coordinate ranged from 0 to 0.4 for a 1 mm thick sample having both sides polished and parallel, and their a* coordinate ranged from −0.1 to +0.1 for a 1 mm thick sample having both sides polished and parallel.

Next, the absorbances were measured as described in the examples above. The results of measurements on samples from the boule heel are collated in table 4.

It may be seen that compounds according to the invention, such that A₃₅₇/A₂₈₀ is <1, are characterized by a weak afterglow, lower than 200 ppm after 100 ms. As mentioned above, thermoluminescence can be used to demonstrate the property of afterglow. FIG. 2 compares the thermoluminescence intensity of a compound in the case of example 2 (referenced “2” in the figure) after an air annealing according to the invention and in the case of example 1 (referenced “1” in the figure, unannealed reference sample) representative of the prior art. These measurements were carried out using a heating rate of 20 K/min on compounds of the same geometry and surface finish (polished) and for the same irradiation time. A very substantial drop in the thermoluminescence intensity, especially around 300 K, is noticed in the case of the example according to the invention, this being characteristic of reduced afterglow

In addition, crystals according to the invention, containing a substantial quantity of Ce⁴⁺, have a better light yield than crystals containing little Ce⁴⁺. This increase in the light yield could be connected to a decrease in the phenomenon of self-absorption. A few relative light yields (i.e. ratio of the light yield of the sample of the example to the light yield of the reference sample) characteristic of this improvement are given in table 5.

TABLE 5

| | Example 1 | | |
|---|---|---|---|
| Relative light yield | (reference) | Example 2 | Example 3 |
| Unannealed | 1 | 1.19 | 1.12 |
| Annealed in air | 1.13 | 2.28 | 1.30 |
| 1500° C./48 h | | | |

Other measurement were made using gamma-ray excitation of the same crystals. These measurements were carried out using the pulse height method, the principle of which is the following: the crystal is optically coupled to a photomultiplier and coated with a plurality of PTFE (Teflon) layers. Next the crystal is excited using γ-ray radiation from a ¹³⁷Cs (662 keV) source. The photons created by the scintillator are detected by the photomultiplier, which delivers a proportional response. This event is counted as an event in a channel of the detection apparatus. The number of the channel depends on the intensity and consequently on the number of photoelectrons created. A high intensity corresponds to a high channel value.

The results are given in table 6.

TABLE 6

| Light yield | Example 1 | | |
|---|---|---|---|
| (channel) | (reference) | Example 2 | Example 3 |
| Unannealed | 904 | 992 | 1099 |
| Annealed in air | 890 | 1112 | 1333 |
| 1500° C./48 h | | | |

Table 7 collates the percentage improvements in the decay times measured relative to a reference crystal annealed in air (reference example 1) for identical geometry and surface finish (polished) and geometries. For example, an improvement of 8% means that the decay time was reduced by 8%. The results presented in table 4 are given for crystals taken from the boule heel, annealed in air.

TABLE 7

| | Example 2 | Example 3 | Example 4 |
|---|---|---|---|
| Improvement | 8% | 4.5% | 2.7% |
| in decay time | | | |
| (%) | | | |

1. A scintillating material comprising a cerium-doped rare-earth silicate, wherein its absorbance at a wavelength of 357 nm is less than its absorbance at 280 nm.

2. The material as claimed in claim 1, wherein the material has an afterglow of less than 200 ppm after 100 ms relative to the intensity measured during an X-ray irradiation.

3. The material as claimed in claim 1, wherein cerium represents 0.005 mol % to 20 mol % of all the rare earths included in the material.

4. The material as claimed in claim 1, which is codoped with a divalent alkaline earth element M or a trivalent metal M′.

5. The material as claimed in claim 4, which is codoped with a divalent alkaline earth element M present in a proportion from 0.0025 mol % to 15 mol % of the sum of all the rare earths included in the material.

6. The material as claimed in claim 4, which is codoped with a trivalent metal M′ in a proportion from 0.005 mol % to 25 mol % of the sum of the moles of silicon and of trivalent metal codopant included in the material.

7. The material as claimed in claim 4, wherein the sum of the masses of the codopants in the material is less than the mass of cerium in the material.

8. The material as claimed in claim 4, wherein the sum of the masses of the codopants in the material is less than 0.1 times the mass of cerium.

9. The material as claimed in claim 1, wherein the rare earth is one or more elements chosen from the following group: Y, La, Pr, Nd, Sm, Eu, Gd, Tb, Dy, Ho, Er, Tm, Yb, Lu.

10. The material as claimed in claim 1, which has the formula Ln_{(2-z-x)}CeₓM_{z}Si₍ₚ₋ᵥ₎M′ᵥO₍₃₊₂ₚ₎in which:
Ln represents a rare earth;
M represents a divalent alkaline earth element;
M′ represents a trivalent metal;
(z+v) is greater than or equal to 0.0001 and less than or equal to 0.2;
z is greater than or equal to 0 and less than or equal to 0.2;
v is greater than or equal to 0 and less than or equal to 0.2;
x is greater than or equal to 0.0001 and less than 0.1; and
p is equal to 1 or 2.

11. The material as claimed in claim 1, which has the formula Lu_{(2-y)}Y_{(y-z-x)}CeₓM_{z}Si₍₁₋ᵥ₎M′ᵥO₅ in which:
M represents a divalent alkaline earth element;
M′ represents a trivalent metal;
(z+v) is greater than or equal to 0.0001 and less than or equal to 0.2;
z is greater than or equal to 0 and less than or equal to 0.2;
v is greater than or equal to 0 and less than or equal to 0.2;
x is greater than or equal to 0.0001 and less than 0.1; and
y is from (x+z) to 1.

12. The material as claimed in claim 11, wherein y ranges from 0.08 to 0.3.

13. The material as claimed in claim 1, wherein, for a 1 mm thick sample having both sides polished and parallel, L* is greater than 93 and at most equal to 100, b* lies in the range from 0 to 0.4 and a* lies in the range from −0.1 to +0.1, L*, b* and a* being the color coordinates in the CIELAB space, obtained using transmission measurement.

14. A method for preparing a material as claimed in claim 1, which comprises an oxidizing heat treatment up to a temperature of between 1100° C. and 2200° C. in an atmosphere containing at least 10 vol % of oxygen, followed by cooling that results in said material, said heat treatment and said cooling both being carried out in an atmosphere containing at least 10 vol % of oxygen when the temperature is greater than 1200° C. and preferably when the temperature is greater than 1100° C.

15. The method as claimed in claim 14, wherein the oxidizing heat treatment is carried out in an atmosphere containing at least 20 vol % of oxygen.

16. The method as claimed in claim 14, which it comprises melting the raw materials in an atmosphere containing less than 5 vol % of oxygen followed by cooling that results in solidification, followed by the oxidizing heat treatment, which is carried out up to a temperature of between 1100° C. and 1600° C.

17. The method as claimed in claim 16, wherein the melting of the raw materials is carried out in an atmosphere containing less than 1 vol % of oxygen.

18. The method as claimed in claim 16, wherein the solidification is a single crystal growth.

19. An ionizing particle detector comprising a material of claim 1 and a photoreceiver.

20. A medical imaging apparatus comprising the detector of claim 19.

21. A scintillating material comprising a cerium-doped rare-earth silicate, the absorbance of which at a wavelength of 357 nm is less than its absorbance at 280 nm, having an afterglow of less than 200 ppm after 100 ms relative to the intensity measured during an X-ray irradiation, cerium representing 0.005 mol % to 20 mol % of all the rare earths included in the material, any rare earth other than cerium included in the material being one or more elements chosen from among the group: Y, La, Pr, Nd, Sm, Eu, Gd, Tb, Dy, Ho, Er, Tm, Yb, Lu, said material being codoped with a divalent alkaline earth M or a trivalent metal M′, the mass of codopant in the material being less than the mass of cerium in the material, said material having color coordinates in the CIELAB space, obtained by transmission measurement using a 1 mm thick sample having both sides polished and parallel, such that L* is greater than 93 and at most equal to 100, b* lies in the range from 0 to 0.4 and a* lies in the range from −0.1 to +0.1.

22. The material as claimed in claim 21, which is codoped with a divalent alkaline earth element M present in a proportion from 0.0025 mol % to 15 mol % of the sum of all the rare earths included in the material.

23. The material as claimed in claim 21, which is codoped with a trivalent metal M′ in a proportion from 0.005 mol % to 25 mol % of the sum of the moles of silicon and trivalent metal codopant included in the material.

24. The material as claimed in claim 21, which has the formula Ln_{(2-z-x)}CeₓM_{z}Si₍ₚ₋ᵥ₎M′ᵥO₍₃₊₂ₚ₎in which:
Ln represents a rare earth;
M represents a divalent alkaline earth element;
M′ represents a trivalent metal;
(z+v) is greater than or equal to 0.0001 and less than or equal to 0.2;
z is greater than or equal to 0 and less than or equal to 0.2;
v is greater than or equal to 0 and less than or equal to 0.2;
x is greater than or equal to 0.0001 and less than 0.1; and
p is equal to 1 or 2.

25. The material as claimed in claim 21, which has the formula Lu_{(2-y)}Y_{(y-z-x)}CeₓM_{z}Si₍₁₋ᵥ₎M′ᵥO₅ in which:
M represents a divalent alkaline earth element;
M′ represents a trivalent metal;
(z+v) is greater than or equal to 0.0001 and less than or equal to 0.2;
z is greater than or equal to 0 and less than or equal to 0.2;
v is greater than or equal to 0 and less than or equal to 0.2;
x is greater than or equal to 0.0001 and less than 0.1; and
y is from (x+z) to 1.

26. The material as claimed in claim 25, wherein y ranges from 0.08 to 0.3.

27. A method for preparing a material as claimed in claim 21, which comprises an oxidizing heat treatment up to a temperature of between 1100° C. and 2200° C. in an atmosphere containing at least 10 vol % of oxygen, followed by cooling that results in said material, said heat treatment and said cooling both being carried out in an atmosphere containing at least 10 vol % of oxygen when the temperature is greater than 1200° C. and preferably when the temperature is greater than 1100° C.

28. An ionizing particle detector comprising a material of claim 21 and a photoreceiver.

29. A medical imaging apparatus comprising the detector of claim 28.
